(19) United States
(12) Patent Application Publication
(10) Pub. No.: US 2019/0331526 A1
(43) Pub. Date: Oct. 31, 2019

(54) A Photometric Test System for Light Emitting Devices

(71) Applicant: OPHIR OPTRONICS SOLUTIONS LTD., Jerusalem (IL)

(72) Inventors: Efi ROTEM, Hod Hasharon (IL); Raphael COHEN, Jerusalem (IL); Shimon ELSTEIN, Mercaz Shapira (IL); Mark IVKER, Jerusalem (US); Eliyahu BENDER, Jerusalem (IL); Daniel SEBBAG, Jerusalem (IL); Ilan HABER, Bnei Brak (IL)

(21) Appl. No.: 16/319,477

(22) PCT Filed: Aug. 3, 2017
(86) PCT No.: PCT/IL2017/050862

§ 371 Date: Jan. 22, 2019

Related U.S. Application Data
(60) Provisional application No. 62/370,791, filed on Aug. 4, 2016.

(51) Int. Cl. G01J 1/42; G01J 1/02; G01J 1/04

(52) U.S. Cl. CPC G01J 1/42; G01J 1/0214; G01J 2001/446; G01J 1/0474; G01J 2001/4252; G01J 1/0437

(57) ABSTRACT

A photometric test system for LED luminaires. The system uses photodetective panels to detect and measure light. By placing an optical absorber layer with low reflectivity and low transmissivity over the photodetective panels, a detection surface which is also an absorber is achieved. This absorber reduces reflection of incident light from the device under test (DUT), and light reflected from the photodetective panels. A pinhole array can be conveniently used for this purpose. This enables the measurement area of the system to be essentially no larger than the emitting area of the DUT. A diffuser positioned between the absorber layer and the photodetective panels increases the accuracy of the system. Simulations and experimental results show that this system can measure total flux with an uncertainty of 4.3%. The demonstrated system is used in 2π geometry. The system measures total flux, color parameters (such as CCT, CRI, chromaticity) and flicker.

### FIELD OF THE INVENTION

The present invention relates to the field of photometric test systems for measuring luminous flux characteristics of a light emitting source.

### BACKGROUND

The integrating sphere is the standard instrument for measuring total flux, spectral flux and color of light sources. The fundamental characteristics of integrating spheres are their spherical geometry and the white diffusive coating on their interiors to maximize reflections. In order to achieve acceptable accuracy of measurement, it is required that an integrating sphere be at least 3 times larger than the Device Under Test (DUT). With the size of LED lighting products, such as LED luminaires, ranging from several inches to several feet, the required integrating sphere diameter often reaches 6-10 feet (2-3 meters). Additionally, due to the many reflections within the sphere and from the sphere to the DUT, the effect of the DUT's absorption on the measurement, which is known as self-absorption, is significant and must be calibrated. This calibration must be performed separately for each DUT and depends on the size, type and reflectivity of the DUT.

There are some prior art photometric test systems that are not integrating spheres, but rather boxlike structures with photo-detective solar panels on the walls facing the Device Under Test (DUT). In U.S. Pat. No. 7,804,589 to I-S. Tseng et al, entitled “System and Method for Testing Light Emitting Devices”, there is described a method for testing light-emitting devices batch-wise, associated with a system for the same purpose, using a moving carrier unit. In U.S. Pat. No. 8,773,655 to H-T. Cheng et al, entitled Total Luminous Flux Measurement System and Total Luminous Flux Measuring Method”, there is described a total luminous flux measurement system and a method thereof for measuring a total luminous flux of a light emitting component. However, due to the non-insignificant level of reflectivity of the solar panels in such systems, there is also a non-insignificant level of reflection off the DUT and back onto the solar panels that affects the measurement. Therefore, like integrating spheres, such systems must be calibrated differently for each type of DUT. This level of solar panel reflectivity and the constant need for recalibration decrease both the accuracy and the efficiency of such systems.

There therefore exists a need for a more compact, efficient and accurate photometric test system which overcomes at least some of the disadvantages of prior art systems and methods.

The disclosures of each of the publications mentioned in this section and in other sections of the specification, are hereby incorporated by reference, each in its entirety.

### SUMMARY

The present application describes new exemplary systems for measuring the spectral flux and total luminous flux of a light emitting source. Such systems may be absolutely calibrated for self-absorption effects arising from the nonzero reflection of incident light from photo-detection panels and again from the Device Under Test. Consequently, such systems are suitable for multiple sizes and types of DUTs, increasing the efficiency and accuracy of measurement over prior art systems. Furthermore, such systems need not be larger than the DUT, spherical geometry is not required, and the measurements provided by the system are not affected by the geometry of the DUT or by the incidence angle of light emitted from the DUT.

Such an exemplary system may comprise an enclosure with one or more walls adapted to receive light from a light-emitting source (DUT). The walls of the enclosure have a light absorbing layer, a diffusing layer, and a photo-detective layer over at least most of their areas. The light absorbing layer is the closest layer to the light-emitting source and is a low-transmission and low-reflection layer that absorbs most of the light incident on it from the light emitting source. According to one implementation, the light absorbing layer has a plurality of pinholes that provide penetration of luminous flux of light through this absorbing layer to ultimately reach the photo-detective layer. The photo-detective layer receives this portion of light from the light emitting source and emits a signal corresponding to a measurement of light impinging on its light receiving surface. The diffusive layer is positioned in between the light absorbing layer and the photo-detective layer and receives light through the pinholes of the light absorbing layer. The diffusive layer then diffuses the light it receives from each pinhole in a predetermined angular distribution onto the photo-detective layer such that the angle of light incident on the diffusive layer does not affect the signal, and thus the measurement, provided by the photo-detective layer.

The light absorbing layer absorbs the majority of light (i) incident thereon from the light-emitting source and (ii) incident thereon from light reflected from the photo-detective layer. This approach essentially eliminates reflections inside the enclosure and between the enclosure and the DUT. Thus, light reflected from the walls of the enclosure and from the photo-detective layer towards the interior of the enclosure and the DUT is minimal such that it does not detract from the accuracy of measurement. It is known with good accuracy how much light is absorbed by the light absorbing layer, and since the vast majority of light from the light-emitting source will be either absorbed in the absorbing layer (the majority of the light) or received and measured by the photo-detectors (a minority of the light), almost all light emitted from the light-emitting source is thus taken into account in the measurement of the incident light and in the calculation of the flux density. This arrangement, wherein most of the light from the DUT is absorbed in the light absorbing layer, is made possible because of the high level of sensitivity of the photo-detective layer, relative to the levels of illumination available from typically measured DUTs. This allows the small amounts of light impinging on the photo-detective layer after attenuation by the light absorbing layer, to be detected and measured with a high level of accuracy. This is in contrast to prior art systems that have multiple reflections that cannot always be accurately predicted or measured, and in which some of the light becomes “lost” from the measurement. The above described light absorbing approach of the presently disclosed systems also provides an advantage over prior art systems that do not intentionally use multiple reflections but that have a significant level of solar panel reflectivity, for example, prior art systems in which light reflects off solar panels and back towards the DUT or out of the enclosure, and thus interferes with the accuracy of measurement.

As an alternative to having an absorbing layer with pinholes, it is possible to use a non-perforated layer that absorbs over the whole of its area, having optical properties that allow a small percentage of the incident light to be transmitted to the photo-detective layer while maintaining very low reflection back to the DUT. Such a layer thus acts in the same way as the pinhole array, limiting reflections from the DUT back into the volume of the enclosure, and limiting reflections from the photo-detective layer back towards the volume of the enclosure and the DUT.

As an alternative implementation, the device may comprise photodiodes disposed within apertures in an absorbing layer. Since the majority of light from the DUT is absorbed by the absorbing layer, there is very little light reflected back from the measurement surface towards the DUT, from which reflections could interfere with the accuracy of the measurement. The spatially sampled portion of light that is collected by the photodiodes passes through a diffusing element disposed on the light impingement surface of each photodiode, such that angular dependent effects are mitigated.

Such exemplary systems of this disclosure further comprise a spectrometer and a flicker sensor. The spectrometer provides measurements used to determine spectral flux and color quality parameters such as CCT (Correlated Color Temperature), CRI (Color Rendering Index), and chromaticity.

There is thus provided in accordance with an exemplary implementation of the devices described in this disclosure, a system for measuring the total luminous flux of a light emitting source, comprising:

a measurement volume, comprising one or more walls adapted to receive light from the light-emitting source, at least a substantial part of at least one of the walls comprising:
(a) a photo-detective layer having a light receiving surface, the photo-detective layer adapted to emit a signal corresponding to a measurement of light impinging on the light receiving surface, and
(b) a light absorbing layer disposed in proximity to the light receiving surface of the photo-detective layer, and having an absorption to wavelengths of light emitted by the light emitting source substantially greater than the transmission of the wavelengths therethrough, and substantially greater than the reflection of the wavelengths therefrom, wherein the level of the absorption of the light absorbing layer is configured such that it absorbs the majority of light from the light-emitting source incident thereon, and the majority of light incident thereon from light reflected from the photo-detective layer.

In such a system, the light absorbing layer should have an absorption for wavelengths of light emitted by the light emitting source greater than the transmission of the wavelengths through the light absorbing layer. Additionally, according to one implementation of such systems, the reflection from the light absorbing layer may be less than 6%, or it may even be less than 3%.

Yet further implementations of such systems may comprise an optical diffusing layer disposed between the photo-detective layer and the light absorbing layer. In any of such systems, the light absorbing layer may have diffusing properties to light passing therethrough. In such a case, the light absorbing layer may comprise at least one of:

(i) a uniform thickness of diffusive black ink,

(ii) a surface having texturing, and

(iii) scattering particles embedded in the light absorbing layer,

such that the light absorbing layer diffuses the light passing through it.

According to an alternative implementation, the light absorbing layer may be essentially opaque except for a plurality of pinholes providing the transmission of the light therethrough onto the photo-detective layer. In such a case, the density and size of the pinholes are such that the absorption by the absorbing layer of the light emitted by the light emitting source is substantially greater than the transmission of the light therethrough. In any embodiment incorporating pinholes, the plurality of pinholes may be configured to provide access of a spatially sampled portion of light from the light emitting source onto the photo-detective layer. Such a pinhole absorbing layer may further comprise variable density filters disposed in proximity to the light receiving surface of the photo-detective layer opposite the pinholes, such that the attenuation of light passing through the variable density filters is dependent upon the angle of incidence of the light on the pinholes. In any of these cases, the light absorbing layer comprising the pinhole array may be applied using (i) screen printing (ii) digital printing or (iii) a sticker having a printed pattern of pinholes, applied directly to the photo-detective layer.

In accordance with yet other implementations of such systems, as an alternative to the implementations using pinholes, the light absorbing layer may have uniform transmittance. Furthermore, any light absorbing layer may be a separate layer of material. Alternatively, the light absorbing layer may comprise black matte paint.

Yet other implementations may involve a system wherein the level of the absorption of the light absorbing layer is such that the light absorbing layer absorbs more than 94 percent of light incident thereon from the light-emitting source, and more than 94 percent of light incident thereon from light reflected from the photo-detective layer.

In any of the above described systems, the photo-detective layer may be comprised of at least one solar panel, which can be a rigid panel or a flexible solar panel deposited on a thin polymer layer.

Different implementations of the measurement volume may include a closed rectangular box with at least a substantial part of at least one of the walls comprising a transparent plate, and the light emitting source mounted on or suspended from the transparent plate, or a mirror on at least one wall of the measurement volume configured to reflect light to at least one of the walls adapted to receive light from the light-emitting source.

Yet other embodiments of such systems may comprising a photo-sensor, the photo-sensor providing a signal for inputting to a flicker measurement module. Additionally, such systems may further comprise a fiber optic sensor, the fiber optic sensor being configured to deliver light incident on it to a spectrometer. Such a spectrometer may provide information relating to the spectral properties of light emitted from the light-emitting source. The fiber optic sensor may be multi-furcated, such that the fiber optic sensor collects light at least two points from within the measurement volume. The system may also comprise an integrated temperature sensor.

Still other example implementations involve a system for measuring the total luminous flux of a light emitting source, comprising a measurement volume comprising one or more walls adapted to receive light from the light-emitting source, at least a substantial part of at least one of the walls comprising:
(a) a light absorbing layer having an array of apertures, and
(b) a plurality of photodiodes having light receiving surfaces, at least some of the photodiodes being disposed relative to the apertures that they measure light passing through the apertures, and at least some of the photodiodes comprising a diffuser in proximity to its light receiving surface.

In such a system, the level of the absorption of the light absorbing layer may be such that it absorbs the majority of light incident thereon from the light-emitting source. In either of these systems, the density of the array of apertures and the size of the apertures are such that the absorption by the light absorbing layer of the light emitted by the light-emitting source is substantially greater than the transmission of the light therethrough. The light absorbing layer may be screen printed or digital printed, or it alternatively may comprise black matte paint. In all such cases, the level of the absorption of the light absorbing layer may be such that the light absorbing layer absorbs more than 94 percent of light incident thereon from the light-emitting source. In any event, the light absorbing layer should have an absorption for wavelengths of light emitted by the light emitting source greater than the transmission of those wavelengths through the light absorbing layer.

### BRIEF DESCRIPTION OF THE DRAWINGS

The present invention will be understood and appreciated more fully from the following detailed description, taken in conjunction with the drawings in which:

FIG. 1 shows a schematic drawing of an exemplary photometric test system;

FIG. 2 shows close-up detail of an exemplary path of a light ray entering and passing through a wall of the enclosure of an exemplary photometric test system;

FIG. 3 shows an alternative implementation of this disclosure, in which the absorbing plate can be realized by using an array of photodiodes;

FIG. 4 shows a graph of the incidence angle on the photo-detective layer versus the normalized response of the photo-detective layer with and without a diffusive layer;

FIG. 5 shows an exemplary simulation that analyzes the effect of normalized response on measurement accuracy; and

FIG. 6 shows a schematic drawing of an alternative implementation of the present disclosure that employs a variable density filter.

### DETAILED DESCRIPTION

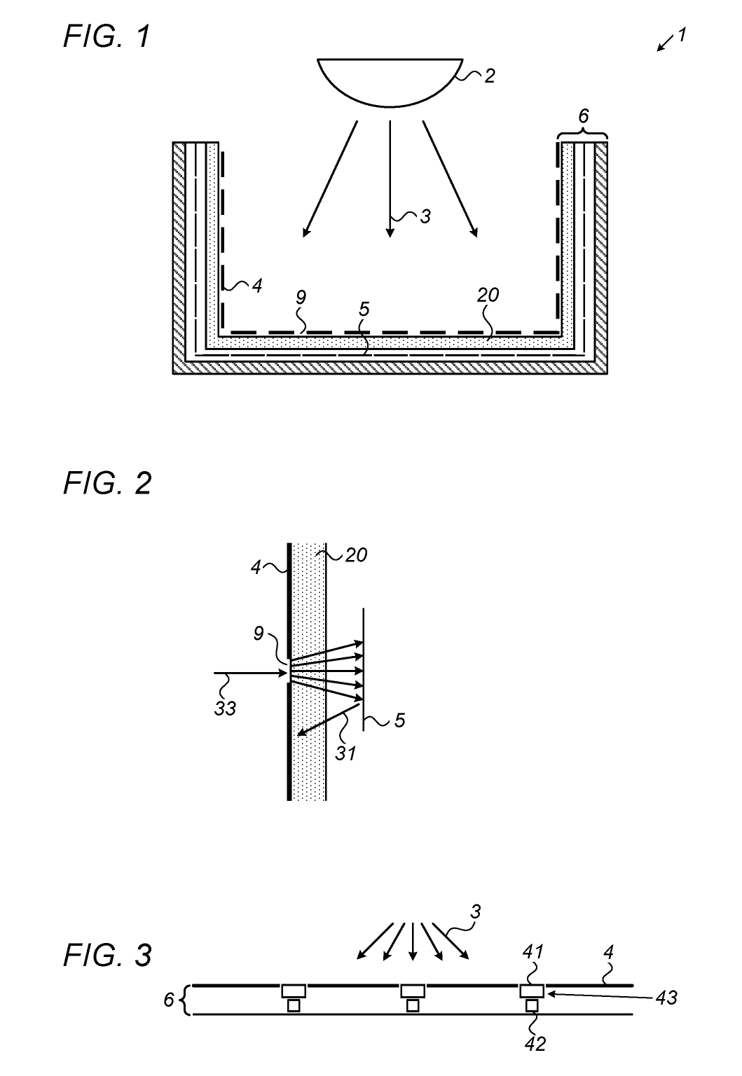

Reference is first made to FIG. 1, which is a schematic drawing of an exemplary system for measurement of the luminous flux emitted by light emitting devices, according to the present disclosure. The enclosure of this implementation is shown as a rectangular box 1, with its internal sides and bottom lined with a photo-detective layer 5. The light emitting source 2, for example, an LED luminaire, is located above the top of the box 1 such that it emits illumination 3 into the box 1 for absorption by the photo-detective layer 5. In a novel arrangement, the walls of the system 6 comprise the photo-detective layer 5, a diffusive layer 20, and a light absorbing layer 4, whose functions will be explained in further detail below. In this exemplary system, all five of the walls 6 of the enclosure 1 have a photo-detective layer 5, an absorbing layer 4, and a diffusive layer 20, though alternative implementations exist with such layers on only some of the walls.

The photo-detective layer 5 may be comprised of photo-detectors, photo-diodes or solar cells, for detecting light and converting it into a measurable electrical signal. The relationship between the intensity of the light reaching the detection surface and the intensity of the electrical signal produced, otherwise referred to as the responsivity, is known for any given wavelength of light. The uniformity of solar panel responsivity is high. For example, when illuminated with white, red, green and blue LEDs, the uniformity of the photocurrent of the solar panels for all of these LED types may generally be better than ±0.3%. The system is used in 2π geometry with the light emitting source positioned over the opening and facing the enclosure walls; thus, the system measures light that is emitted from the light emitting source into a solid angle of 2π steradians.

The system may have a controller (not shown in Figures) that generally includes a microprocessor incorporating software programs for automating various aspects of the measurement operations.

FIGS. 1 and 2 illustrate how the photo-detective wall structure of the enclosure 1 differs from that of prior art enclosures. As shown in FIG. 1, each wall 6 of the enclosure 1 comprises a photo-detective layer 5, a diffusive layer 20, and a light absorbing layer 4. In this novel arrangement, the absorbing layer 4 and the diffusive layer 20 are disposed in front of the absorbing surface of the photo-detective layer 5, and the absorbing layer 4 incorporates an array of pinholes 9 to allow a small part of the illumination 3 to pass through to the photo-detective layer 5, but absorbing the majority of the incident illumination.

The light emitting source 2 projects light rays 3 towards the wall of the enclosure 6. The light absorbing layer 4 is shown to be the innermost layer of the enclosure, and is the first layer to receive light 3 from the light emitting source 2. The light absorbing layer 4 may be painted with an opaque, high-absorption black matte paint such that most of its surface is absorptive. Due to the low reflectance level of the black matte paint, only a small percentage of the light emitted by the light emitting source 2 is reflected back into the volume of the system. The light absorbing layer 4 absorbs the majority of light incident thereon, both light incident thereon from the light-emitting source 2, and also light reflected from the photo-detective layer 5 that falls on the opposite side of the absorbing layer 4 to that of the light source 2. Such a majority of light absorbed by the absorbing layer 4 from both sides may be for example, 90%, 95% or 98%, or even more, of the light incident thereon.

The light absorbing layer 4 may comprise a dense array of pinholes 9 through which a minority of light 3 may pass to the diffusive layer 20 and ultimately to the photo-detective layer, where it is measured. Light incident on the panel 6 of the enclosure 1 is therefore spatially sampled by this dense pinhole array 9.

A diffusive layer, or diffusing plate 20, is shown in between the light absorbing layer 4 and the photo-detective layer 5, whose function is described more fully in accordance with FIG. 2. The diffusive layer may be realized using surface texturing, or a diffusing material such as PTFE (Teflon), or barium sulfate paint. Unlike some prior art systems, the photo-detective layer 5 is unexposed to the environment of the enclosure box, and is thus protected from dust accumulation and damage. The diffusive layer 20 extends along essentially the full length of the enclosure walls 6 so that the photo-detective layer 5 is essentially fully protected on both sides by the outer wall of the box 1 and by the diffusing layer 20.

FIG. 2 shows a close-up detail of the wall of FIG. 1, showing a single ray of light 33 passing through a pinhole 9 and through the wall. The diffusive layer 20 diffuses the light ray 33, which is a spatially sampled portion of the light from the light emitting source, in a predetermined distribution onto the photo-detector 5 such that the original angle of incidence of the light ray 33 on the diffusive layer 20 does not affect the measurement generated by the system. A reflected ray 31 from the photodetector 55 is shown reaching the black paint of the absorbing layer 4 from the inside where it will be essentially completely absorbed and thus will not interfere with the measurement. After receiving the diffused distribution of light, the photo-detector 5 emits a signal used for measurement of its received light.

FIG. 3 shows an alternative implementation of this disclosure, in which the absorbing plate is realized by using an array of photodiodes 42. This implementation essentially combines the functionality of the absorbing layer, the diffusing layer, and the photo-detective layers of FIGS. 1 and 2 into a single layer within the wall 6 of the enclosure. The absorbing plate 4 comprises photodiodes 42 dispersed at intervals within small apertures 41 in the absorbing plate. The small apertures 41 have pinhole functionality; they spatially sample the light incident on the layer. As in the implementation of FIGS. 1-2, the absorbing plate 4 has a surface of an opaque, low reflectivity material such as black matte paint. Instead of a separate diffusing layer, each photodiode 42 comprises a cosine corrected diffuser 43. Such a cosine corrected diffusers may be constructed of materials such as opal glass, PTFE, or fused silica incorporated with tiny air bubbles. For a small packaged photodiode of the type that would be used in the presently described implementation, the diffuser may be in the form of a disk with diameter of the order of 2 to 10 mm and 1 to 3 mm thick. Raising the disk 0.5 to 1 mm above the surrounding surface generally improves the cosine correction. In summary of the implementation of FIG. 3, essentially all the light emitted from the DUT will either be absorbed by the absorbing plate 4 or diffused by the diffuser 41 of the photodiode 42 and subsequently measured.

In yet another alternative implementation of the present disclosure, the pinhole array is applied directly on the solar cells or solar panels using screen printing or digital printing, or a sticker having a printed pattern of pinholes applied to the panels. A diffusing layer is not needed in this implementation because the apertures of the pinhole array are cosine corrected, provided that the absorbing layer with the pinhole array is sufficiently thin.

In yet another implementation of the present disclosure, instead of a pinhole array, a uniform absorbing layer, such as black ink, is applied to the photo-detective layer. The thickness of the layer of ink is controlled, for example to be 30 μm thick over the entire area of the photo-detective layer, and the ink is selected to have a limited predetermined reflectivity, and high absorptivity. Thus, this uniform layer has a predefined and uniform transmittance with a good cosine corrected response. The uniform transmittance allows light to pass through to the photodetectors. Such a layer may be very thin, for example 30 μm, or it may have a surface relief, such as of cone shapes, or it may have scattering particles impregnated in the layer giving the layer diffusive properties without the need for a separate diffusing layer.

In any of the above implementations of the present disclosure, the photo-detective layer may be realized by using flexible solar panels such as amorphous silicon solar panels deposited on a thin polymer layer, such as PET (polyethylene terephthalate). This will allow for creation of a variety of measurement cavities with different shapes.

While it is understood that the most common embodiment is to have the absorbing layer, diffusive layer, and photo-detective layer on all the walls of the enclosure, alternative implementations may have these layers only on a substantial portion of one of the walls of the enclosure. For example, the system can be built with a single absorbing plate, such as at the bottom of the measurement enclosure that may be positioned close to and opposite the DUT. This arrangement makes this implementation of the system very simple, small and lightweight. Alternatively, the system can be built as a box with a single absorbing plate on one wall, and mirrors that reflect light from the DUT to the absorbing plate. For example, one efficient arrangement of this disclosure positions the single absorbing plate on the bottom of the enclosure, and the mirrors on the side walls of the enclosure.

The following section now presents the mathematical derivation of the spectral flux and total flux measurement, using inputs from one of the exemplary systems described above. For clarity, it is assumed that the detection surface responsivity is spatially uniform and is not sensitive to illumination angle. It is further assumed a spectrometer is used to sample the spectrum of the DUT and that the spectral content of the DUT is uniform in all directions. A more realistic analysis is brought in the next section.

The total current, I, produced by the photo-detective layer is given by:

I=∫R(λ)Φₑ(λ) (1)

where R(λ) is the responsivity of the photo-detective layer in [A/W], and Φₑ(k) is the spectral flux of the DUT in [W/nm]. The spectrometer measures the normalized spectrum S(λ) given by:

$$S ( λ ) = \frac{{Φ}_{e} ( λ )}{{Φ}_{e}} \qquad ( 2 )$$

where Φₑ is the total flux of the DUT in [W]. The normalization is achieved by scaling S(λ) such that ∫S(λ)dλ=1.

Having measured S(λ) with the spectrometer, color quality parameters such as CCT, CRI, and chromaticity can be calculated directly since they depend only on the spectral profile.

Substituting (2) into (1) and rearranging yields

$${Φ}_{e} = \frac{I}{\int R ( λ ) S ( λ ) d λ} \qquad ( 3 )$$

Substituting again into (2) yields the spectral flux in [W/nm]

$${Φ}_{e} ( λ ) = I \frac{S ( λ )}{\int R ( λ ) S ( λ ) d λ} \qquad ( 4 )$$

Having obtained the spectral flux Φₑ(λ), the total luminous flux in lumens is calculated using:

$${Φ}_{v} = \int {Φ}_{e} ( λ ) V ( λ ) d λ = I \frac{\int S ( λ ) V ( λ ) d λ}{\int R ( λ ) S ( λ ) d λ} \qquad ( 5 )$$

where V(λ) is the human visual sensitivity function or photopic function.

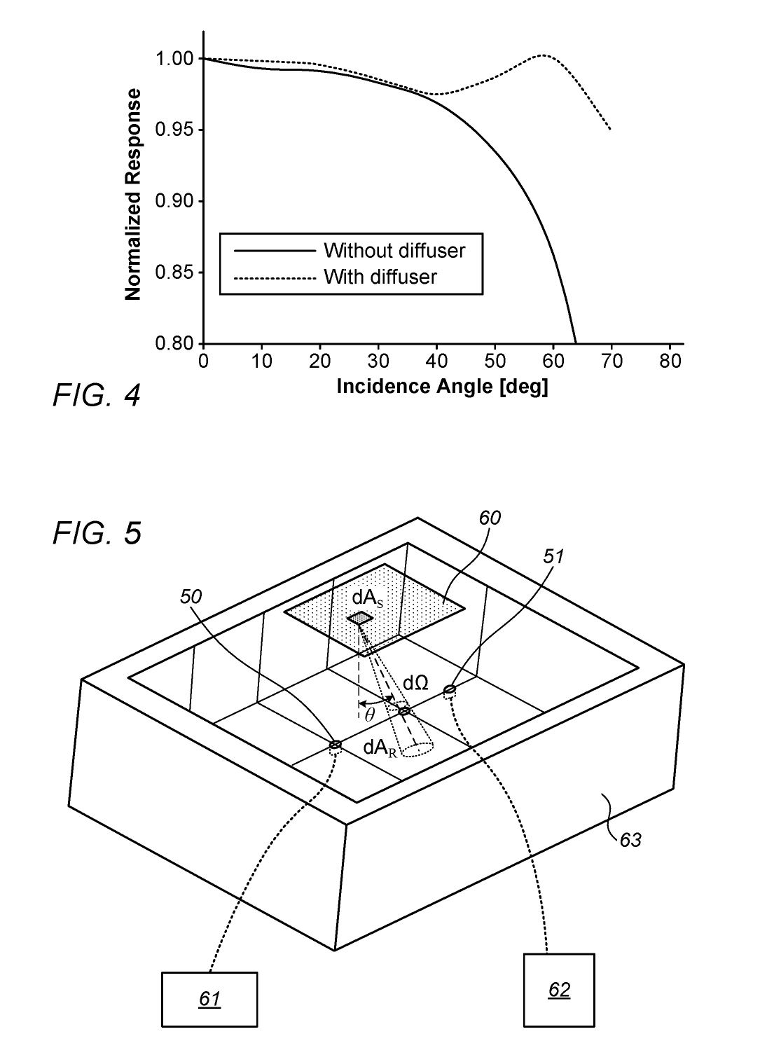

As mentioned previously, the angular dependence of the photo-detective layer's responsivity on illumination angle is low with use of the diffusing plate, increasing the accuracy of measurement. FIG. 4 is an exemplary graph showing the responsivity as function of illumination angle, K(θ), of the photo-detective layer of the presently disclosed system to white LED light, with and without a diffusive layer. Ideally, K(θ) should equal 1, indicating that the responsivity of the photo-detective layer does not change with the illumination angle of light incident thereon. As may be seen in the graph, above an incidence angle of 40 degrees, there is a significant advantage of the presently disclosed wall structure having a diffusive layer in this respect. Furthermore, the rectangular shape of the box prevents light from reaching the walls of the enclosure at very high angles. It is to be understood that, in the alternative implementations of this disclosure, the diffusive layer may be incorporated within the photo-detective layer, such as the diffusing portion of the photo-diodes, or may be incorporated within the absorbing layer, such as with the impregnated particles. The diffusive properties of the wall structure of these alternative implementations provide similar advantages in the reduction of angular dependence to the responsivity of the photo-detective layer.

FIG. 5 shows the exemplary system of FIGS. 1-2, and a mathematical simulation that analyzes the effect of normalized response as a function of incidence angle of the photo-detective layer, K(θ), on measurement accuracy.

In this model, the LED luminaire 60 is positioned over the enclosure opening. The luminaire surface is divided into area elements dA_{S}, and the detection surfaces are divided into area elements dA_{R}. For every dA_{S} and dA_{R}, the flux element dΦ, incident on dA_{R} is calculated, based on the subtended solid angle dΩ and the luminance, L of the luminaire. The total incident flux on the photo-detective layer is given by:

Φᵥ=∫∫_{A}_{_{S}}_{A}_{_{R}}dΦᵥ,

and the total detected flux of the photo-detective layer is given by:

Φ′ᵥ=∫∫_{A}_{_{S}}_{A}_{_{R}}K(θ)dΦᵥ.

The difference in the ratio between Φᵥ and Φ′ᵥ for different luminaire sizes and illumination beam angles is the uncertainty contribution of the nonideal K(θ). As the luminaire size and beam angle increase, more rays hit the panels at high slant angles (greater angles of incidence) and the effect of K(θ) is more noticeable. Thus, it is desirable to use a diffusing plate that keeps K(θ) as close to 1 as possible. As shown previously in FIG. 4, an exemplary system of this disclosure has K(θ) very close to 1 for angles less than 40 degrees and is within 0.05 of the full normalized response for angles between 40 and 70 degrees.

Referenced is now made to Table 1 below, which shows that the error due to the sensitivity to illumination angle, K(θ), of the presently disclosed system ranges between −1.2%, for a small and narrow beam DUT, and −6.3%, for a large and wide beam DUT. If the system is calibrated using a calibration standard with a beam angle of 80° FWHM, the error will be shifted to ±2.6%.

Below is a table showing the reduced photocurrent due to angular response of an exemplary solar panel for different luminaire sizes and beam angles using an enclosure of 640 mm (length)×480 mm (width)×160 mm (height):

TABLE 1

| Luminaire | Beam angle [Deg. FWHM] | | | | | |
|---|---|---|---|---|---|---|
| size [mm] | 20 | 40 | 60 | 80 | 120 | 150 |
| 70 × 50 | −1.2% | −2.2% | −3.1% | −3.7% | −4.0% | −4.0% |
| 100 × 75 | −1.2% | −2.2% | −3.1% | −3.7% | −4.0% | −4.0% |
| 150 × 100 | −1.2% | −2.2% | −3.1% | −3.7% | −4.0% | −4.0% |
| 200 × 150 | −1.2% | −2.2% | −3.1% | −3.7% | −4.0% | −4.0% |
| 300 × 200 | −1.2% | −2.2% | −3.1% | −3.7% | −4.0% | −4.1% |
| 400 × 300 | −1.2% | −2.2% | −3.2% | −3.8% | −4.2% | −4.2% |
| 600 × 435 | −2.2% | −3.8% | −4.7% | −5.3% | −5.6% | −5.7% |
| 620 × 460 | −3.8% | −5.0% | −5.6% | −6.0% | −6.3% | −6.3% |

Furthermore, since this is a systematic and predictable error, in a novel method of the present disclosure, a correction factor can be applied based on the size and beam angle of the luminaire being measured. An example of this correction is shown in table 1 below, which shows the reduced photocurrent due to angular response of the solar panel for different luminaire sizes and beam angles. For example, for a luminaire size of 70×50 mm and a FWHM angle of 20 degrees, a correction factor of −1.2% should be applied to the calculation of total flux. By measuring the current of individual solar cells or photodiodes in the absorber array, information on the angular distribution of light from the DUT can be obtained. By modeling the system's response to various DUT sizes and beam angles, as shown for instance in the table below, correction factors can be applied. There may be software controlling the system that applies these correction factors automatically, upon receiving the DUT size and beam angle.

In addition to the photo-detective layer 5, which may be covered by an absorbing layer on the inner walls of the enclosure, the implementation shown in FIG. 5 includes additional features implemented by other sensors located at the bottom of the enclosure. A fiber optic sensor 50 may be incorporated, which delivers light to a spectrometer 61 for calculation of the spectral flux Φₑ(λ) as described above. Additionally, a photodiode 51 may also be incorporated at the bottom of the enclosure. This photodiode may be used to measure rapid temporal changes in the lighting intensity of the DUT 60 known as the ‘flicker’ of the DUT. A flicker monitor 62 may be used to make this measurement in order to ensure that the light emitting source complies with standards. In addition, an integrated temperature sensor (not shown in Figures) monitors the temperature inside the system and controls fans in the walls of the enclosure 63 to maintain a desired temperature within the system. The system is thus capable of measuring spectral flux [W/nm], total flux [lumen], color parameters such as CCT and CRI, and flicker.

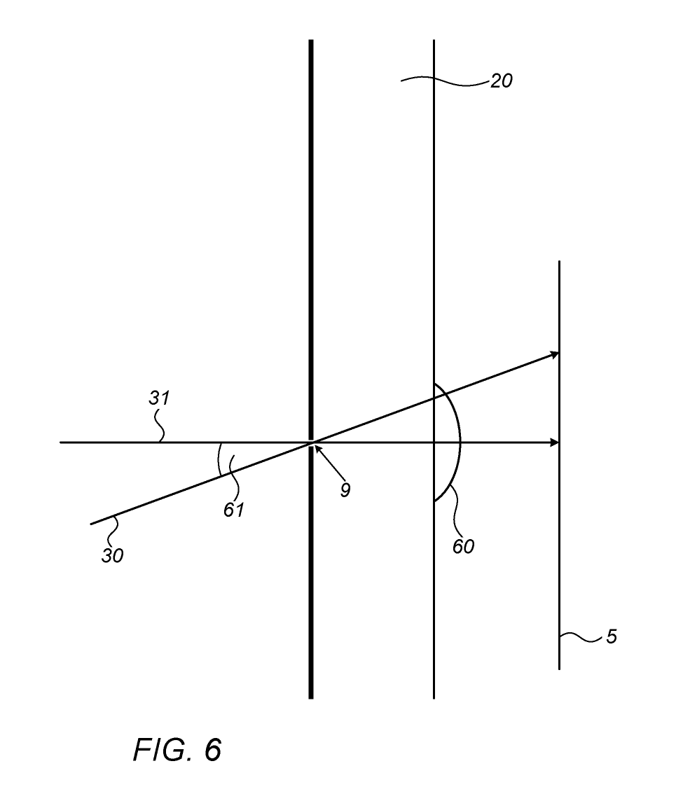

FIG. 6 shows an implementation of the present disclosure that employs a variable density filter 60. Such a variable density filter may be used as an alternative to a diffusing layer as a means to eliminate the problem of angle dependent absorption on the photo-detective layer 5. The angle dependent absorption of the photodetectors can be equalized by applying the variable density filter 60 on the back side of a transparent but not diffusive plate 20 opposite each pinhole 9. Thus, each pinhole 9 creates a ‘pinhole camera’ effect, transforming the angle of illumination to position. The variable density filter 60 has its highest level of absorption in its center and an increasingly lower density and lower level of absorption going away from its center. The pinhole 9 is small enough such that all angles of light going through the pinhole 9 pass through a single point at the pinhole aperture. Thus the proper density of the filter 60 can be determined based on the expected amount of flux of each possible angle of light passing through this single point.

To illustrate this implementation, a ray of light 30 having a certain luminous flux, passing through the pinhole 9 normally without the variable density filter would have a predefined luminous flux density on the surface of the photodetector 5. On the other hand, a ray of light 31, having the same luminous flux as ray 30, incident at an angle 61 to the normal (approximately 35 degrees in FIG. 6), will have a reduced luminous flux density on the light impinging surface of the photodetector because of its angular incidence thereon, and will thus will be detected by the photo-detective layer as if it had a lower luminous flux. The variable density filter 60 compensates for this effect by attenuating the normally incident ray 30 more than the ray 31 falling at a greater angle of incidence, thereby equalizing the illumination measured by the photo-detective layer. The spatial profile of the attenuation of the filter should be calculated such that it compensates for the angular dependency of the transmission through the filter, and the angular responsivity of the solar cell. This is done in the example shown in FIG. 6 by using an absorber having a uniform absorbance, but having a thickness profile tailored to achieve the desired spatial compensation. Alternatively, the variable density filter could be implemented by using a parallel plate of material of a material having a spatially graded absorbance across the width of the plate.

As an alternative to the implementation of the single fiber optic sensor 50 in FIG. 5, where the spectrum is sampled at a single position on the bottom of the enclosure, a multi-furcated fiber optic sensor may be used for more accurate spectral measurement. If the spectral flux of the source is the same in all directions, the measured spectrum and the average spectrum are the same; however, this is not a realistic case. The uniformity of the spectrum affects both the color measurement accuracy and the total flux measurement accuracy. This uncertainty is evaluated using equations (1)-(5). For example, some real luminaires with different spectra give an uncertainty of about ±15° K in the CCT and ±2% in the total flux. However, by using a multi-furcated fiber sensor, the spectrum of light can be collected from several positions in the enclosure surface and this total sampled data can be delivered to the spectrometer 61 as a spatially averaged sample of the spectrum of the illumination.

In most prior art integrating sphere systems, self-absorption of the DUT has a large effect on the measurement. This is because the DUT changes the average reflectivity of the sphere which, in turn, greatly affects the sphere's throughput. Calculating this effect is not practical due to the infinite number of reflections that occur inside the sphere, and it must be calibrated for every DUT.

In contrast, in the presently disclosed system, the reflectivity of the black pinhole array seen in FIGS. 1 and 2 is very low, for example, 4%. This example means that 4% or less of the DUT's flux is reflected back towards the DUT. A large and reflective DUT may reflect this light back into the enclosure, while a small or non-reflective DUT will reflect very little. Consequently, the effect of the DUT on the measurement ranges, for example, between 0% and 4%. Only a single reflection is considered in this example, as the next reflection will be attenuated to a negligible level (4% of 4%=0.16%).

Furthermore, in an exemplary method of the present disclosure, LEDs may be placed at different positions on the enclosure walls, allowing the effect of the DUT to be measured. The LEDs point outward and a measurement is taken with these LEDs serving as the light source with the DUT removed, and then with the DUT placed on the system, with the DUT is off during both of these measurements. The difference between the two measurements is due to the reflection of the DUT and can be used to calculate the effect of the reflectivity of the DUT on the system measurement.

The following correction methods of the present disclosure can be applied to mitigate this small reflectivity of the light absorbing layer and its effects:

(a) A fixed 2% may be added to the initial calibration to shift the error from 0%-4% to ±2%.

(b) A phenomenological correction may be applied based on the size and tone of the luminaire surface.

(c) A light source may be added to the system for automatic reflection correction. The light source may be activated with and without the DUT present. The measured signal in these two cases can be used to determine the reflection from the DUT and be used to correct the measurement of the DUT. For example, a LED on the bottom of the enclosure may flash to measure the reflectance of the DUT right before the measurement is made.

The uncertainties discussed in the previous sub sections are summarized in Table 2 below. Table 2 shows uncertainty contributors and the percentage of uncertainty of each contributor, with and without correction factors, and including total percentages. The uncertainty, and the corrected uncertainty is shown for each uncertainty contributor. Since there are systematic errors, they are summed arithmetically and not geometrically (rms). The resulting total uncertainty is, for example, 7.8%. However, by applying various correction factors as described earlier, a low total uncertainty, for example, of 4.3%, can be reached.

TABLE 2

| | | Uncertainty |
|---|---|---|
| | | with |
| | | correction |
| Uncertainty contributor | Uncertainty | factors |
| Initial total flux calibration | 1% | 1% |
| Non uniformity of solar panel responsivity | 0.3% | 0.3% |
| Angular response of the solar panel | 2.5% | 1% |
| Localized spectrum measuring | 2% | 1% |
| Secondary reflection from the DUT | 2% | 1% |
| Total | 7.8% | 4.3% |

The initial total flux calibration is an absolute calibration, such as for NIST standards. It is known that the optical output of light sources changes as the source heats up, until it reaches thermal equilibrium. Waiting until the DUT reaches thermal equilibrium to perform optical measurements may be inefficient in terms of the time taken to perform the measurement. It is therefore advantageous to be able to perform optical measurement shortly after the DUT is turned on, and, based on that measurement, to confidently predict the optical output after the DUT will have reached thermal equilibrium. In a novel exemplary method of the present disclosure, the system software performs measurements over long periods of time, for example hours or days, and based on the information gathered, the software automatically determines the optimal timing for measurement, shortly after the DUT is turned on, the relationship between the measurement and the optical output after the DUT has reached thermal equilibrium, and the confidence level of this prediction. A fast photodiode incorporated in the presently disclosed systems can be used to automatically detect when the DUT is turned on and thus to apply the required delay before the measurement in a precise and controlled fashion, for example, to commence the measurement automatically and at a controlled time delay following the turning on of the DUT.

Although it is understood that the most common implementation of the enclosure is a rectangular box as shown in FIG. 1, alternative implementations of this disclosure may have enclosures of different shapes, such as a square or triangle. As mentioned previously, the use of flexible solar panels such as amorphous silicon solar panels deposited on a thin layer of PET (polyethylene terephthalate) allows for creation of a variety of measurement cavities with different shapes. In addition, some measurement cavities may be fully enclosed, having a roof in which the light emitting source 2 is mounted or suspended. In one implementation of this disclosure, a transparent plate is placed over the opening of the system that supports the DUT 2 and performs both diffuser and pinhole functionality. Such an arrangement is useful for a light source that emits backwards towards the roof or opening of the enclosure.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

1. A system for measuring the total luminous flux of a light emitting source, comprising;
a measurement volume, comprising one or more walls adapted to receive light from said light-emitting source, at least a substantial part of at least one of said walls comprising:
a photo-detective layer having a light receiving surface, said photo-detective layer adapted to emit a signal corresponding to a measurement of light impinging on said light receiving surface; and
a light absorbing layer disposed in proximity to the light receiving surface of said photo-detective layer; and having an absorption to wavelengths of light emitted by said light emitting source substantially greater than the transmission of said wavelengths therethrough; and substantially greater than the reflection of said wavelengths therefrom,
wherein the level of said absorption of said light absorbing layer is configured such that it absorbs the majority of light from said light-emitting source incident thereon, and the majority of light incident thereon from light reflected from said photo-detective layer.

2. A system according to claim 1, wherein said light absorbing layer has an absorption for wavelengths of light emitted by said light emitting source greater than the transmission of said wavelengths through said light absorbing layer.

3. A system according to claim 1, wherein said reflection from said light absorbing layer is less than 6%.

4. (canceled)

5. A system according to claim 1, further comprising an optical diffusing layer disposed between said photo-detective layer and said light absorbing layer.

6. A system according to claim 1, wherein said light absorbing layer has diffusing properties to light passing therethrough.

7. A system according to claim 1, wherein said light absorbing layer is essentially opaque except for a plurality of pinholes providing said transmission of said light therethrough onto said photo-detective layer.

8. A system according to claim 7, wherein the density and size of said pinholes are such that said absorption by said absorbing layer of the light emitted by said light emitting source is substantially greater than the transmission of said light therethrough.

9. A system according to claim 7, wherein said plurality of pinholes is configured to provide access of a spatially sampled portion of light from said light emitting source onto said photo-detective layer.

10. (canceled)

11. A system according to claim 7, wherein said light absorbing layer comprising said pinhole array is applied using (i) screen printing (ii) digital printing or (iii) a sticker having a printed pattern of pinholes, applied directly to said photo-detective layer.

12. A system according to claim 1, wherein said light absorbing layer has uniform transmittance.

13. A system according to claim 1, wherein said absorbing layer disposed in proximity to said light receiving surface of said photo-detective layer is a separate layer of material.

14. A system according to claim 6, wherein said light absorbing layer comprises at least one of:
(i) a uniform thickness of diffusive black ink;
(ii) a surface having texturing; and
(iii) scattering particles embedded in said light absorbing layer,
such that the light absorbing layer diffuses said light passing there-through.

15. A system according to claim 1, wherein said light absorbing layer comprises black matte paint.

16. A system according to claim 1, wherein the level of said absorption of said light absorbing layer is such that said light absorbing layer absorbs more than 94 percent alight incident thereon from said light-emitting source, and more than 94 percent of light incident thereon from light reflected from said photo-detective layer.

17. A system according to claim 1, wherein said photo-detective layer is comprised of at least one solar panel.

18. A system according to claim 17, wherein at least one solar panel is a flexible solar panel deposited on a thin polymer layer.

19. A system according to claim 1, wherein said measurement volume is a closed rectangular box with at least a substantial part of at least one of said walls comprising a transparent plate, and said light emitting source is mounted on or suspended from said transparent plate.

20-21. (canceled)

22. A system according to claim 1, further comprising a fiber optic sensor, said fiber optic sensor being configured to deliver light incident thereupon to a spectrometer.

23. A system according to claim 22, wherein said spectrometer provides information relating to the spectral properties of light emitted from said light-emitting source.

24-25. (canceled)

26. A system for measuring the total luminous flux of a light emitting source, comprising;
a measurement volume, comprising one or more walls adapted to receive light from said light-emitting source, at least a substantial part of at least one of said walls comprising:
a light absorbing layer having an array of apertures; and
a plurality of photodiodes having light receiving surfaces, at least some of said photodiodes being disposed relative to said apertures that they measure light passing through said apertures, and at least some of said photodiodes comprising a diffuser in proximity to its light receiving surface.

27-32. (canceled)
